(19) United States
(12) Patent Application Publication
(10) Pub. No.: US 2015/0207266 A1
(43) Pub. Date: Jul. 23, 2015

(54) Connection clip for powering active-use instrumentation

(71) Applicants: Cheryl Kellond, Manhattan Beach, CA (US); Sylvia L. Marino, Mill Valley, CA (US)

(72) Inventors: Cheryl Kellond, Manhattan Beach, CA (US); Sylvia L. Marino, Mill Valley, CA (US)

(21) Appl. No.: 13/999,169

(22) Filed: Jan. 23, 2014

(51) Int. Cl. H01R 13/62; H01R 13/24

(52) U.S. Cl. CPC H01R 13/62; H01R 13/2407

(57) ABSTRACT

Technology for measuring and supporting physical activity or sports performance in actual field use requires that the physical instrumentation operate with minimal hindrance to the users performance. Power must flow securely and without interruption between any active-use device (whether sensor(s), or display(s)) and a power supply; and the physical connector effecting such power flow must stay secure against anticipated, ordinary, physical stresses from its user's activity (i.e. sports performance). This invention details a physical connector, specifically a connection clip, that is secure against unidimensional or randomly combined motion(s) yet responsive to specific, orthogonally-dimensioned, deliberate and controlled affixation and release motions, that effects such a secure physical connection.

### CROSS REFERENCE TO RELATED APPLICATIONS

This application for patent claims priority under 35 U.S.C. 119(e), particularly §119(e)(3), from U.S. provisional application filed for the invention described therein by the same inventors which was filed on Jan. 24, 2013 by Express Mail Certificate, Post Office to U.S. Patent and Trademark Office, EM Certificate #El 449614 US, and given by the U.S. Application No. 61/849,327; and this application and Specification expressly reference that original provisional application.

### STATEMENT REGARDING FEDERALLY SPONSORED RESEARCH OR DEVELOPMENT

Not Applicable

### 1.A. FIELD OF THE INVENTION

No instrumentation works either sua sponte or in complete isolation. A sensor which is never read, or never sends a report in, is worthless; any instrument without power to function is useless weight.

In laboratories and medical facilities instrumentation transmits its data either by people (technicians, professionals, rarely the actual individual who is the source and subject of sensing and analysis) or by a direct physical linkage (wire); and depend on the latter entirely for their electrical power. More importantly, the source and subject individual(s), the instrument's user(s), must constrain the source individual's position and range of motion within the limitations of both the instrumentation and connections. A laboratory or medical facility is an artificially-constrained model of the real world—one cannot run a marathon over actual terrain trailing a plugged-in power cord.

Measuring external and/or internal conditions, and the concurrent performance, of individual human beings has changed dramatically for the better. We have gone from measuring illness to measuring health; from monitoring individuals struggling to keep function and life going, to those striving to improve and enhance their functions and lives. Each human being is healthiest when physically active within whatever limits that individual can sustainably manage. Reciprocally, the healthier we are, the more we engage in any exercise and the more active we tend to be. Why else do we use the adjective ‘lively’ to describe a better-than-normal performance or appearance?

Active-use instrumentation, and the included class of sports instrumentation, at present both uses sensors and depends on electrical power. It is possible to get power from batteries; yet batteries are drained by use. The greater the demand, the quicker a battery runs down and the larger a battery needs to be to sustain the same duration of use.

For any given battery composition the only way to store more power is to have a larger—which means a heavier—battery. While one can add a weight at the wrist (or ankle) as an exercise enhancement, this becomes a potential concern when the weight added is that of sports instrumentation (including its battery). Especially when the goal is to measure as closely as possible the normal, i.e. unburdened, active performance of the user; because adding battery weight becomes a self-defeating distortion. Furthermore, physiology and physics both dictate that an active user experiences the least distortion from any additional mass, when it is carried closest to that user's center of mass.

To connect a power source (wall outlet or battery) to an electronic device requires a connecting wire. For that wire to be removably connectable, each end will have a plug which mates into and up with a corresponding, though dimorphically complementary, socket. Typically one side of each such connection will have at least one protruding, exposed metal contacts and be referred to as a ‘male’ or ‘plug’ end, while its corresponding, though dimorphically complementary partner with inset and protected metal contact is referred to as the ‘female’ or ‘socket’ end.

### 1.B. BACKGROUND OF THE INVENTION

Anyone using a portable instrument or device which depends on continued electrical power has encountered the weighty problem posed by batteries. With modern manufacturing and materials, these very often are the heaviest, and most frequently replaced, part. Physically distancing any electrical instrument from its power source requires a direct physical connection—a power cord; and making any power cord both connectable and separable requires joining elements, i.e. paired connectors, commonly referred to as a ‘plug’ and ‘socket’.

There are a great many ‘standard’ electrical connectors in the world. (For an overview, see http://en.wikipedia.org/wiki/Electrical_plug.) Prior art uses ‘male’ plugs and ‘female’ sockets which provide and combine both the electrical connection and the gripping and holding force joining distal and proximal connectors which allow electrons to flow between a power source and an electrical device. The vector for each of the physical and electrical connections runs parallel, and aligns, with the logical (or model) vector of connectivity; in short, all of device, cord, connectors and power source form a line.

The great majority of connectors incorporate a shared, common, flaw of having a single point of failure—the joining elements can be separated by a single-vector force. In plain English: a direct yank outward on the cord pulls the plug from the socket. Anyone who has used a ‘weed-wacker’, vacuum cleaner, or other portable, electrically-powered, non-battery device, i.e. a device whose continued operation depends on its power cord staying plugged in, has probably experienced the sudden (and usually unexpected and frustrating) loss of power when that device's power cord's plug was pulled free from the socket while the device was in use.

There is a generous dollop of prior art concerning coupling means enabling the plug end of an electrical cord to retain engagement with its mating socket. Excluded from consideration for this present application should be:
the sub-field of additional ‘helper’ structures or elements which form a coupling device preventing accidental separation of the electrically connected cord plug during ordinary usage (Slenczka, T. J., U.S. Pat. No. 7,407,405, issued Aug. 4, 2008; Puzio, M., U.S. Pat. No. 7,081,004, issued Jul. 24, 2006; McQuirter, G., U.S. Pat. No. 6,997,734 issued Feb. 14, 2006; Elswick, L. B., U.S. Pat. No. 5,584,720, issued Dec. 17, 1996; Sanner, D. et al., U.S. Pat. No. 5,582,524, issued Dec. 10, 1996; Osten, F. F., U.S. Pat. No. 5,336,106, issued Aug. 9, 1994; Magnuson, J. W., 5,328,384, issued Jul. 12, 1994; Cross, A. L., U.S. Pat. No. 5,211,573, issued May 18, 1993; Pioszak, R., U.S. Pat. No. 4,957,450, issued Sep. 18, 1990; Odbert, L. E., U.S. Pat. No. 4,940,424, issued Jul. 7, 10-1990; Bosworth, D. et al., U.S. Pat. No. 4,925,399, issued May 15, 1990; Windsor, J. F. Jr., U.S. Pat. No. 4,875,874, issued Oct. 10, 24-1989; Kopeski, M. J. Jr., 4,773,874, issued Sep. 27, 1988; Shugart, J. F. Jr., U.S. Pat. No. 4,221,449, issued Sep. 9, 1980; Dobson, J. H., U.S. Pat. No. 4,145,105, issued Mar. 20, 1979; Howell, R. D., U.S. Pat. No. 3,999,828, issued Dec. 28, 1976; Gilman, E. J. et al.; U.S. Pat. No. 2,903,669, issued Sep. 8, 1959; Schueneman, A. J., U.S. Pat. No. 2,406,567, issued Aug. 27, 1946);
the sub-field requiring additional, mating and matching, screw-threaded linking elements (Kovacik, J. D. et al.; U.S. Pat. No. 6,135,803, issued Oct. 24, 2000; Jack, S. R., U.S. Pat. No. 5,454,728, issued Oct. 3, 1994; Iversen, R. et al.; U.S. Pat. No. 4,540,230, issued Sep. 10, 1985; Child, E. S. et al., U.S. Pat. No. 2,739,290, issued Mar. 20, 1956, Markey, R. I., U.S. Pat. No. 2,306,821, issued Dec. 29, 1942);
the sub-field incorporating additional rotating, sliding, or moving elements (Berger, T. R. et al., U.S. Pat. No. 6,905,360, issued Jun. 14, 2005; Sowers, D. A., U.S. Pat. No. 5,316,493, issued May 31, 1994; Shaffer, H. R. et al., U.S. Pat. No. 3,986,765, issued Nov. 19, 1976; Johnsen, C. T., U.S. Pat. No. 4,907,985, issued Mar. 13, 1990);
the sub-field using internal leverage and pressure on at least one moveable blade to increase the frictional holding force of the prongs (Burton, J. E., U.S. Pat. No. 7,175,463, issued Feb. 13, 2007; U.S. Pat. No. 7,140,192, issued Nov. 28, 2006; U.S. Pat. No. 7,052,303, issued May 30, 2006; U.S. Pat. No. 6,948,963, issued Sep. 27, 2005; U.S. Pat. No. 6,896,537, issued May 24, 2005; and, U.S. Pat. No. 6,676,428, issued Jan. 13, 2004;); and,
any sub-field concentrating on a wall-outlet and its faceplate connections (Fields, K. N. et al., U.S. Pat. No. 5,989,052, issued Nov. 23, 1999; Leong, H., U.S. Pat. No. 4,420,204, issued Dec. 13, 1983); or other aspects of electrical control.

There are many varieties of connectors for data transfer as well. Most of these constitute variations on the ‘male’ and ‘female’ plug approach, varying chiefly by the shape, number, and internal wiring of the individual pins within the connectors. These range from Ethernet to Firewire to serial, parallel, video-direct-interface (‘VDI’), and the ubiquitous USB connectors (1.0, 2.0, etc.). These should also be excluded from consideration for this invention as their focus is on effecting the transfer of ‘meaningful electrons’, those bearing information, an entirely separate and different field of concern contradistinct from the provision of electrical power.

Since active-use instrumentation in its expected and normal use will experience active motion (probably rapid, and also probably energetic), any link between the active-use instrumentation and an external element (additional sports instrumentation and/or battery) will need to endure single, and repeated, pulls and tensionings, possibly from many, and differing, vectors. What active-use instrumentation needs is something which prevents disconnection from otherwise-separating pulls and tensions which may occur during normal, which is to say athletic and energetic, motions of the athlete during her sports activity.

The focus of the embodiments described herein is on the securing of continued transference of electrons for power (or in a further embodiment both power and meaning) through a wire using complementary, dimorphic paired elements to comprise a removable yet secure connector which holds against external forces that could separate the connection between instrument and power source. It addresses the problem of how to keep one electrical device connected to any of the set of a power-supplying cord, power-supplying wall outlet, power-supplying battery, and power-providing source; or, in its further embodiments, any of a power and/or data-supplying cord (thus, even a power-and-data-supplying cord), which in turn is connected to any of a set of battery, wall outlet, further power cord, other power source, or another instrument or computational resource. These embodiments focus on doing so without any extra clips, screws, or tape as additional and secondary ‘securing’ elements. Though described in general with a preferred embodiment which provides power to a clip-on GPS or data-transmitting unit which is additional to any display or distal, secondary instrumentation, these embodiments focus on the connector keeping a device ‘plugged in’, even when the user is both wearing it and furthermore, also engaging in athletic activity or other active movement, and not the instrument or device which is being powered.

### SUMMARY OF THE INVENTION

A power cord's traditional plug-and-socket electrical connection can be separated by a one-dimensional pull, as long as that pull is along the vector running along the connection. A sideways pull on the power cord does not separate the plug from the socket, but a pull on the cord away from the join, will do so—with greater effectiveness the more the pull runs along with, rather than out from, the line formed by the power cord. Plug-and-socket connections are thus susceptible to failing from unwanted movement of a single dimensionality.

However, distinctly differentiated from the traditional plug-and-socket, the embodiment described herein does not rely on direct friction and in-line insertion of the connecting metal elements; instead, the embodiment orthogonally separates the ‘holding’ and ‘transmitting’ dimensions and effects these through complementary dimorphic forms. The present embodiment thus uses directions of electrical and physical connection which are off-set and orthogonal to the principle axis formed by the power cord between the device and source of electrical power it connects with.

The connection clip which forms the present embodiment of the invention takes advantage of the fact that electrons can travel through a right angle without noticeable effort, to separate the vectors of electrical and physical connection; and then further uses a matching and mating, but complementarily-shaped, pair of connectors (a ‘gripping’ and a ‘linking’, as opposed to a ‘male’ and ‘female’, pair). It uses physical geometry at the human level to require particular and orthogonal vectors of effort to effect a separation of the power cord from its device, thereby eliminating most combinations of random motions from a greatly-constrained intentional set which effect the release and separation of the connection clip. The embodiment's linking connector falls into the homeomorphism class of ‘one hole, one tail’ (cf. http://en.wikipedia.orgiwiki/Topology.)

### BRIEF DESCRIPTION OF THE DRAWINGS

FIG. 1 is an overview of a connection clip as herein detailed prior to its connectors being joined; instead of the connection being formed by the pushing, or screwing, together standard and traditional ‘male’ and ‘female’ plug-and-socket sub-elements, it comprises as its pair of complementary dimorphic elements (each of which has an insulating shaped body as its outer shell and within that a set of electrically-conductive wires) a gripping element (1) (shown on the left side of the drawing with its connected spring hinge (5) and capping plate (7) open such that the latter is below and opposite the gripping element's interior surface, and analogizable to a ‘male’ plug), which is incorporated into a device (in this drawing, a wireless GPS sensor), and a linking element (2) (shown on the right side of the drawing prior to placement in the gripping element, and analogizable to a ‘female’ socket) that together constitute the connection clip.

FIG. 2 is a close-up view of a the interior face of the gripping element (1) opposite the capping plate (7) (not shown).

FIG. 3 is a close-up view of the interior, opposing face of the capping plate (7).

FIG. 4 is a three-frame view showing the connection clip as its two connectors are joined, i.e. as the gripping element (1) engages and then holds on to the linking element (2) with the first image (FIG. 4A) showing the two connectors close but still separated; the second image (FIG. 4B) showing the two connectors engaging together but not closed; and the third image (FIG. 4C) showing the two connectors in the closed position.

FIG. 5 is a side view of the linking element (2) with the contact bump on the near side visible (but hiding from this perspective the contact bump on the far side) and a power cord (9) for connecting to a power source, extending off the left edge of the drawing (with such connection not shown).

FIG. 6 is a cut-away view of the interior of the linking element (2) and its power cord (9), showing the insulating outer, and conducting interior, parts thereof.

### DETAILED DESCRIPTION OF EXEMPLARY EMBODIMENTS

One of the ways to reduce the problem of unbalancing or distorting mass from a carried active-use instrument (‘device’)—because mass can affect an athlete's or user's activity and performance—is to separate a distally-located device from a massier supporting device (e.g. one incorporating any of a battery or a recording or an analytical element), to enable the user to place the latter close to the center of her torso, or even leave behind during a sustainable period of particularly demanding or active motion. There the supporting device's extra mass will be at the least less unbalancing, will cause less interference with, and demand less effort from, her actions and performance.

A second way to reduce this problem is to link the carried device to a battery recharger between uses, thus enabling reduction or minimalization of the mass of any battery in the carried device.

A third way is to link multiple devices at a distal locations and distances inversely proportional to their mass on complementary (opposing) limbs, effecting a counter-balancing amongst the distally-separated elements, using separable connecting means which do not interfere with each other.

The shared commonality amongst all of these solutions is that each can be effected by providing a physical link between the active-use device carried distally (say, on the forearm) and any supplementing or massier elements carried proximally (at or near the user's center of mass). In the embodiment this link is a power cord which provides an electrical connection between a minimal-weight (and thus minimal-endurance) battery embedded in the active-use instrument worn on the forearm, and a supplemental battery pack carried on the central torso. But this power cord must be, and remain, reliably connected to the active-use device—it should not use connectors which can be yanked out and rendered nugatory by a single-vector pull. The connection formed by the connection clip is, in all of the embodiments, secure enough that there is no loss of power (and/or data) while it is connected.

The present invention embodies a connection clip for electronic power connection, i.e. which provides a repeatably connectable and removable electrical connection, between a power source and a device. Such device may be any of an active-use instrument, which may further comprise any of the set of display, sensor, memory, processor, or wireless link, being carried on a user's body during active effort. The power source may be any external power source that can sustain the operation of, or recharge any battery(ies) embedded, in the device when connected thereto. In the embodiment a first element of the connection clip will be (as shown in the embodiments) embedded in the device, or may be connected to the device, and comprises standard electrical wiring within an insulating shell (that is, a set of electrically-conductive wires); while a second element of the connection clip will extend from and form one end of a power cord whose opposite end connects to a source of electrical power.

The source of electrical power may come from any of the set of standard wall sockets, other power cord ends, power strips, and multi-plugs connected to the electrical grid or an electrical generator, using any of a set of standardized plug-and-socket connectors (all of these being known to the prior art and none claimed or described herein). Most power cords have differentiated ends (′male′ at one end, ‘female’ at the other), but some will have undifferentiated ends (e.g. ‘female’ at each end, or ‘male’ at each end); so any embodiment which has a gripping element and linking element at each end, which connects to a complementary linking or gripping element of the device and/or source, is also expressed herein.

An alternative embodiment can also provide a secure electronic data link through a power-and-data cord from one device to another, whether that other is carried elsewhere on or external to the users body, using internal conductive wiring to transmit electronic data. Another embodiment further comprises an insulating seal between the first and second elements at the set of contacts, which insulating seal is sufficiently water-resistant and in a further embodiment even waterproof, to prevent a short-circuit through the ambient medium (water) in which all of the active-use instrument, athlete, connection clip, and power cord are in.

In an alternative embodiment, this link also provides a direct, physical, and wired communication link between the active-use device and at least one additional active-use device carried elsewhere (such as the upper thigh) to communicate data between the two active-use devices, as opposed to using solely a potentially-interceptable, or interferable, wireless connection to do so. In all of the embodiments the connection clip provides a removably attachable connection between the active-use device and the power cord which itself is at or through its other end, connected to any combination of additional active-use devices, power sources, context-sensing means, data-transference means, and data-recording means.

In all of these embodiments the invention provides each of (a) security against a single-vector pull; (b) continuous electrical connection while in the medium through which the user is moving; and (c) ready attachment and removal through a specific, yet easily-managed, set of orthogonally-diametric motions using more than a single plane or vector of action.

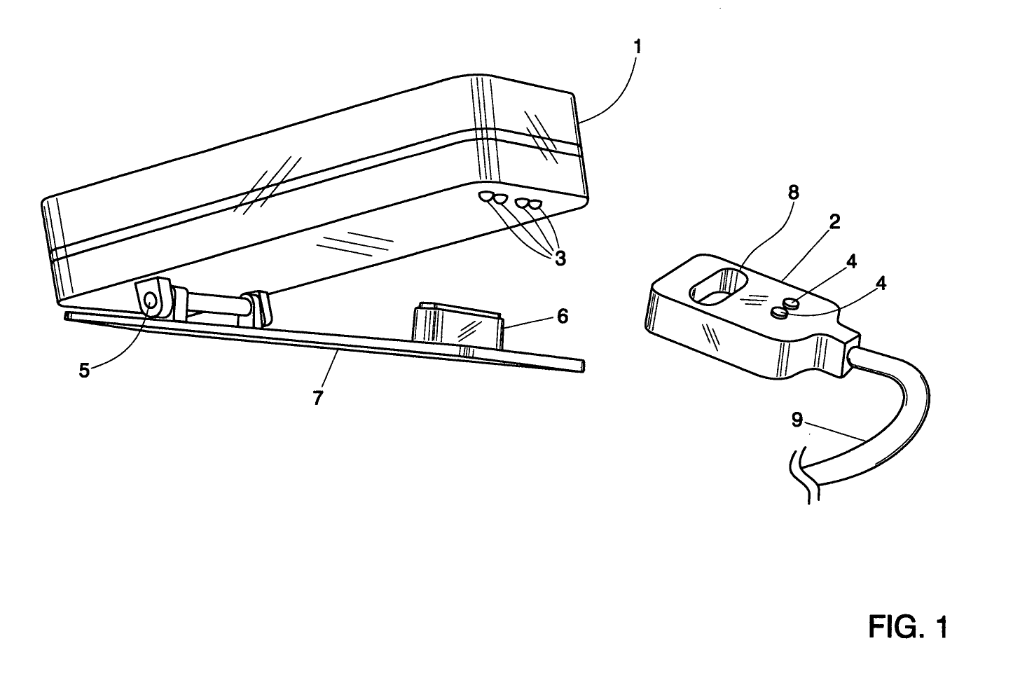

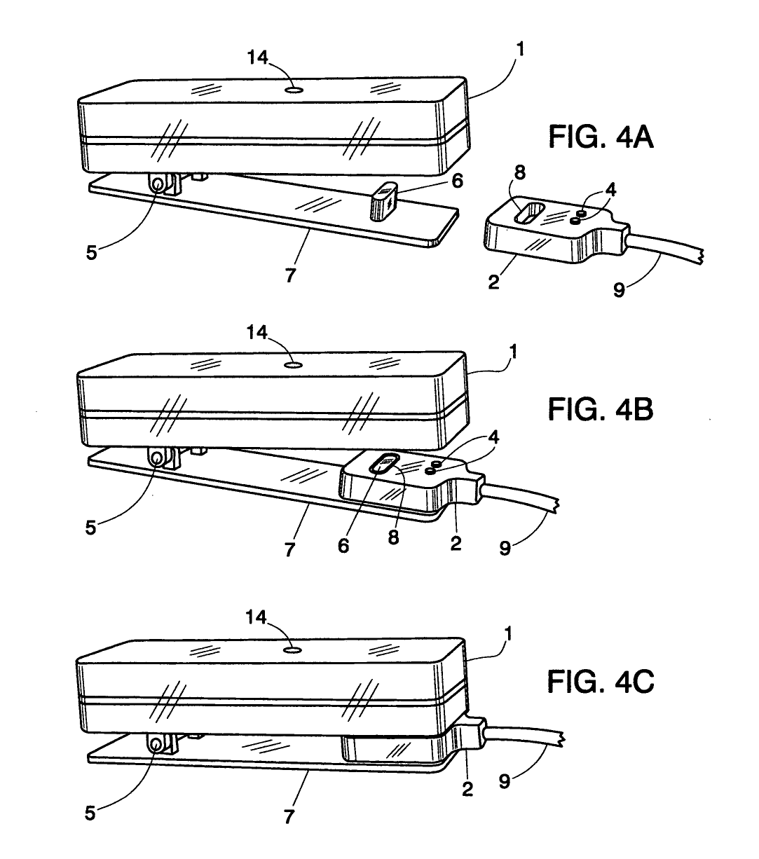

In each embodiment the connection clip (as shown in the drawings and described in the text relating thereto herein) comprises a pair of complementary dimorphic elements (FIG. 1): a gripping element (1) and a linking element (2). The user joins the gripping element (1) and the linking element (2) together to effect the connection going from unjoined to engaged to closed (FIG. 4A, FIG. 4B, FIG. 4C), thereby effecting an electrical linkage through the electrically conductive wires within these elements (and, of course, the power cord). Each of the gripping and linking elements (1, 2), and any power cord (9) leading off from the linking element (2), has a non-conductive outer shell surrounding and insulating a set of internal electrically conductive wires from each other and the outside environment to prevent any short-circuit.

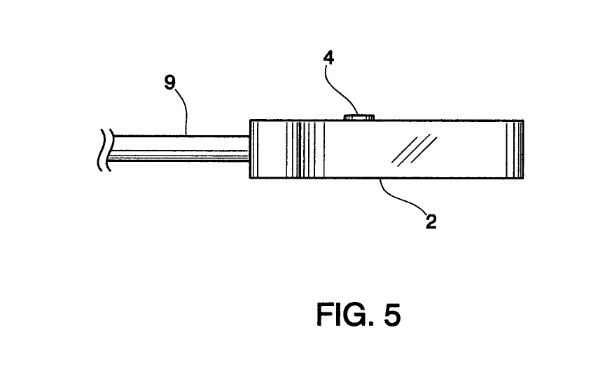

As shown in FIG. 1, the linking element (2) comprises a power cord (9) connecting to an insulating and non-zero-topology-shaped body (one which has at least one central hole (8)), a set of electrically-conductive wires within said insulating, shaped body, and connecting to these, at least one set of electrically-conductive, spring-loaded, contact bumps (4) (two are shown in this drawing) that protrude through minimally and perpendicularly to the chief plane of the linking element's insulated outer shell (as shown in FIG. 5), through which an electrical connection is effected from and through the power cord (9) from the power source. The gripping element (1) shown on the left side of the drawing and incorporated into an active-use device such as a GPS sensor with and through a set of interior electrically-conductive wires (not shown), further comprises an insulating outer shell with a first interior surface; to which is attached a spring hinge (5) offset and near one end of said first interior surface, with the spring hinge also attached to a capping plate (7) with a second interior surface having its axis and width parallel to and opposite said first interior surface, and further having at least one holding tooth (6), extruding from the second interior surface perpendicularly towards the first interior surface, with the holding tooth's shape and form matching the central hole (8) of the linking element (2); while through the gripping element's first interior face opposite the capping plate (7), protrude at least one set of at fixed, perpendicularly-protruding, and electrically-conductive contact points (3) (four are shown in this drawing) which ensure a match, in number and position and thus a flow of electrical power, when the holding tooth (6) is inserted through the central hole (8), between a set of contact points (3) of the gripping element (1) and the set of contact bumps (4) of the linking element (2).

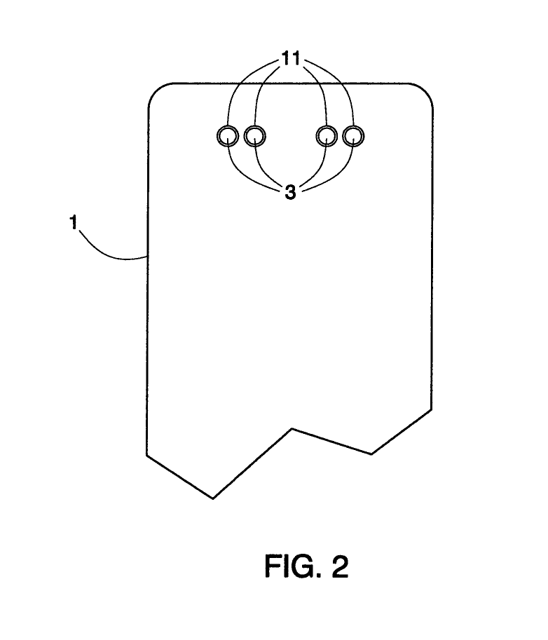

As shown in FIG. 2, the close-up view of the interior face of the gripping element (1) opposite the capping plate (7) (not shown in this drawing), the gripping element (1) further comprises a set of at least one fixed, perpendicularly-protruding, and electrically-conductive contact points (3) which pass through its external and non-conductive shell perpendicularly to this interior face, with said contact points (3) in one embodiment further kept separate from that shell by seals (11) which are water-resistant or in yet a further embodiment, water-proof.

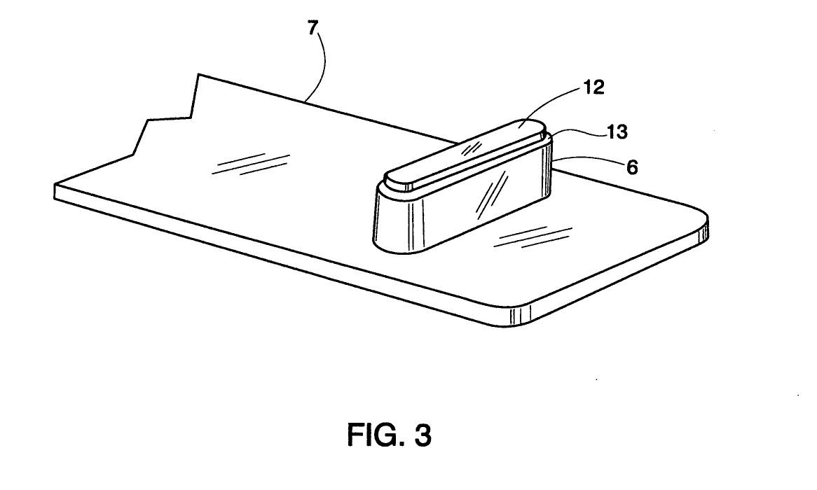

As shown in FIG. 3, the interior, opposing face of the capping plate (7) further comprises at least one holding tooth (6) whose shape and form match the central hole (8) of the linking element (2) (not shown in this drawing), which holding tooth (6) has an insulating separator (12) and a setback (13) to ensure engagement with the central hole (8) without damaging the interior face of the gripping element (1) opposite the capping plate (7).

The operation of the connection clip is shown in the three-stage, stop-motion drawing of FIG. 4 (A, B, and C) as follows: in FIG. 4A, the holding tooth (6) on the interior face of the capping plate (7) has been levered away from the interior face of the gripping element (1) by pressing on the end nearest to the spring hinge (5), thus opening the gripping element (1) so the linking element (2) can be connected. In FIG. 4B, the holding tooth (6) has been inserted through the central hole (8), positioning the linking element (2) and most specifically, its contact bumps (5) where the latter will match up with the set of at least one fixed, perpendicularly-protruding, and electrically-conductive contact points (3) (not visible from this view) on the interior face of the gripping element (1). In FIG. 4C, the spring hinge (5) has returned the capping plate (7) to its closed position, parallel to and opposing the interior face of the gripping element (1), thus placing into direct physical contact (and in the further embodiments mentioned above, sealed contact) the contact points (3) and contact bumps (4), completing the connection between the gripping element (1) and linking element (2). As shown in FIG. 5, the exterior, side view of the linking element (2), the set of contact bumps (4) protrude minimally and perpendicularly to the chief plane of the linking element's insulated outer shell; and more specifically this figure shows their orientation, which is orthogonal (and in this embodiment, perpendicular) to the orientation of the power cord (9), which is in that chief plane and extends directly away from the insulated outer shell, along a line drawn from the central hole (8) (not visible from this view) through the middle of the set of contact bumps (4).

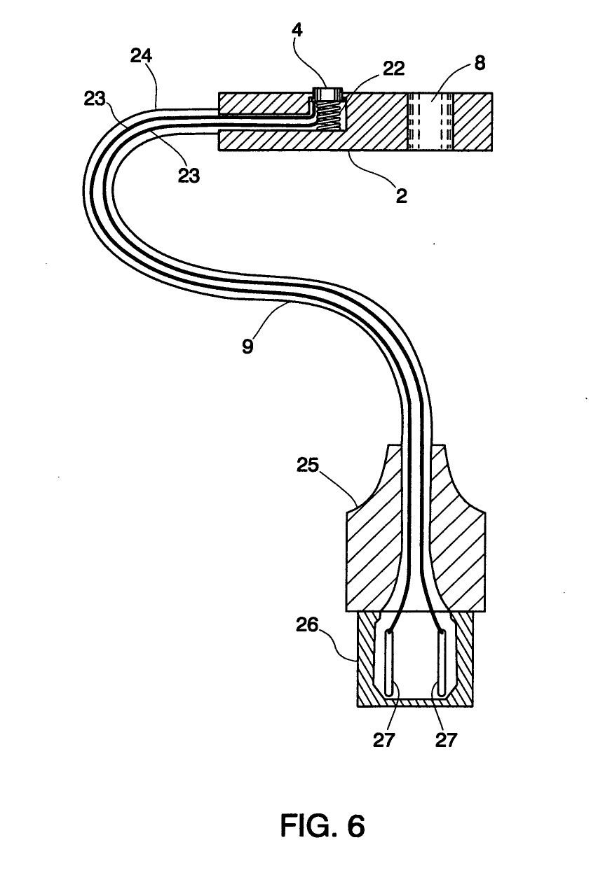

As shown in FIG. 6 the not-to-scale, cut-away view of the linking element (2), a line drawn from the power cord (9) to the central hole (8) as now revealed will pass through the set of contact bumps (4), which are both spring-loaded (22) and connecting to a set of electrically-conductive wires (23); and said electrically-conductive wires (23) continue within the insulating outer shell (24), which together form the power cord (9), that at its far end goes into a second connector (25) belonging to any of the set of a second linking element, a power connector (of a standard form), and a power-and-data connector (of a standard form) (26) with each of the set of electrically-conductive wires (23) at this end of the power cord (9) connecting up with a conductive contact plate (27) to complete the power cord (9), such that it can be plugged into any of the set of standard connections, wall plates, sockets, battery strips, etc. (none shown, as all are known to the prior art and are not claimed herein).

One embodiment can also be described as a connection clip for electronic connection between a pair of devices, further comprising a pair of complementary dimorphic elements, the first being a gripping element (1) and the second a linking element (2), said pair of complementary dimorphic elements further comprising: each of the gripping element (1) and linking element (2) having an insulating shell with electrically conductive wires inside; with said electrically conductive wires inside extending from each of the gripping element (1) and linking element (2) within insulating outer shells to connect with the respective device and power cord and complete an electrical connection from power source to device. Said linking element (2) further comprises a non-zero-topology-shaped body which has at least one central hole (8) and at least a pair of contact bumps (4) protruding through the connecting face of said linking element, offset from said set of contact bumps (4), and perpendicularly to the line drawn from the central hole (8) through the line formed by the set of contact bumps (4) to the power cord (9). Said gripping element further comprises: a spring hinge (5); a capping plate (7) linked by said spring hinge (5) to the main body of the gripping element (1); on the interior face of said capping plate (5), a holding tooth (6) extruding perpendicular to the plane of the capping plate and towards the interior, opposing face of the main body of the gripping element, with a specific shape and form matching the central hole (8) of the linking element (2); at least one set of electrically-conductive contact points (3) extruding through and perpendicularly to that plane of the interior face of the main body of the gripping element, at a distance and alignment matching the offset of the set of contact bumps (4) from the central hole (8) of the linking element (2); such that, the holding tooth (6) and central hole (8) and the contact points (3) and contact bumps (4) are complementarily shaped and positioned so as to make and retain contact with their respective opposites as and when the spring hinge (5) is relaxed, such that the gripping tooth (6) is inserted through the central hole (8), and such that the spring hinge (5), by pressing the contact points (3) into the contact bumps (4), depresses them to effect an electrical connection from the device through the interior wires of the gripping element (1) to its contact points (3) to the contact bumps (4) of the linking element (2) to its interior wires and those of the power cord (9) (as shown in FIG. 4A, 4B, 4C).

As can be seen in the drawings, the join between the holding tooth (6) and central hole (8), and between the contact points (3) and contact bumps (4) are orthogonal and perpendicular to the line of connection between the gripping element (1), linking element (2), and power cord (9). Thus the connection clip is secured against unintended release from any pull or separating force which comes ‘along’ the power cord (9); for such merely pulls against the gripping tooth of the connecting element. Also, any force simply directed against either the gripping element or the linking element will be resisted by the strength of the hinge of the gripping element (or, in a further embodiment, the gripping element's spring hinge and a releasable latch between its first and second interior faces, combined (not shown)) plus the static friction between the gripping element's tooth and the linking element's central hole. Even if the gripping element's tooth is displaced the linking element's linking end is not displaced from the contact pins, or if displaced, will be reconnected the moment the displacing force on the hinge ceases and it re-closes the gripping element.

To fully release the linking element and gripping element, three coordinated, and orthogonally-directed motions must be made: the spring hinge (5) on the gripping element (1) must be pressed to lift up the other end of the capping plate (7), which requires a force vector paralleling the direction of extrusion of the holding tooth (6); the linking element (2) must simultaneously be displaced from and off of the holding tooth (6), requiring a second and parallel force vector solely on the linking element (and not on the capping plate (7); and then both the gripping element (1) and linking element (2) must be moved apart so when the pressure on the spring hinge (5) is released the connection will not be re-established as the capping plate (7) closes once again, requiring a vector which is both perpendicular to the separating vectors and parallel to the long axis of the capping plate (7). While no absolute guarantee is ever feasible—any part of the connection clip, device, power cord, or even the user can be broken or mangled or cut, after all, if an accident is severe enough—the connection is secured against inadvertent release during the reasonably expectable stresses, motions, and demands of even high-energy athletic performance. As the connection no longer is subject to being broken by a single vector force along the line of connection between cord and device, it is considerably more secure.

In a further embodiment, visible in each of FIGS. 4A, 4B, and 4C, the gripping element (1) further comprises an embedded light (14), preferably a low-power LED, connected to the gripping element's interior wires to signal that an electrical power connection is effected and power is flowing which illuminates only when the gripping element (1) and linking element (2) are connected sufficiently to provide electrical power from the power source to the device or to effect an electrical and data connection between the active-use device and the power source and/or supplemental device(s).

An alternative embodiment incorporates into the connection clip in addition to its power connection through the set of contact points (3), contact bumps (4), and interior wires (not shown), at least one data connector which is part of the insulated, now power-and-data cord (9).

Another alternative embodiment incorporates a fitting within the central hole of the linking element comprising a set of contact indents matching a known standard for data and/or power transmission through the power cord (9), including those meeting the standards set for any of a USB, Firewire, Ethernet, or other standard plug, and extruding from the first interior face of the gripping element a complementary set of contact points contained within such a standard plug, and by combining the two when the connecting plate (7) is closed, providing both data and power to, and taking data from, the instrumentation through the connection clip, such that by combining the two when the connecting plate is closed, the connection clip provides both data and power to, and taking data from, the instrumentation through the connection clip.

A yet further alternative embodiment has respective lock-and-key designs for both the gripping element (1) and linking element (2) whereby the holding tooth (6) and inner hole (8) are matched in differing geometries, including higher-order topologies; e.g., with a single inner hole replaced by a sharp edged inner rectangle; with a single inner hole replaced by a pair of ellipses with a separating central band; and with the single and smooth inner hole replaced by an inner hole in the form of ellipse with ‘teeth’ forming the middle interior of the long sides, whereby the holding tooth (6) matches, in respective embodiments, each of these more complex shapes.

A yet further alternative embodiment respectively incorporates in both the gapping element and linking element at least three contact points (3) and contact bumps (4), connecting respectively to ‘ground’ ‘neutral, and ‘hot’ interior wires to enable a ‘3-prong’ and/or grounded, connection.

Another, and yet further, embodiment comprises at least one pair of gripping and linking elements such that any of said pairs, when connected, is sufficient to provide electrical power from the power source to the device.

While this invention has been described in reference to illustrative embodiments, this description is not to be construed in a limiting sense. Various modifications and combinations of the illustrative embodiments as well as other embodiments of the invention will be apparent to those skilled in the art upon referencing this disclosure. It is therefore intended this disclosure encompass any such modifications or embodiments.

The scope of this invention includes any combination of the elements from the different embodiments disclosed in this specification, and is not limited to the specifics of the preferred embodiment or any of the alternative embodiments mentioned above. Individual user configurations and embodiments of this invention may contain all, or less than all, of the elements disclosed in the specification according to the needs and desires of that user. The claims stated herein should be read as including those elements which are not necessary to the invention yet are in the prior art and are necessary to the overall function of that particular claim, and should be read as including, to the maximum extent permissible by law, known functional equivalents to the elements disclosed in the specification, even though those functional equivalents are not exhaustively detailed herein.

Although the present invention has been described chiefly in terms of the presently preferred embodiment, it is to be understood that the disclosure is not to be interpreted as limiting. Various alterations and modifications will no doubt become apparent to those skilled in the art after having read the above disclosure. Such modifications may involve other features which are already known in the design, manufacture and use of power connectors, data connectors, or joint power/data connectors, and which may be used instead of or in addition to features already described herein. The physical elements herein are not limiting but instructive of the embodiment of the invention, and variations which are readily derived through alternatives, substitutions, or transformations which are standard or known to the appropriate art are not excluded by omission. Accordingly, it is intended that the appended claims are interpreted as covering all alterations and modifications as fall within the true spirit and scope of the invention in light of the prior art.

Additionally, although claims have been formulated in this application to particular combinations of elements, it should be understood that the scope of the disclosure of the present application also includes any single novel element or any novel combination of elements disclosed herein, either explicitly or implicitly, whether or not it relates to the same invention as presently claimed in any claim and whether or not it mitigates any or all of the same technical problems as does the present invention. The applicants hereby give notice that new claims may be formulated to such features and/or combinations of such features during the prosecution of the present application or of any further application derived therefrom.

We claim:

1. A connection clip for electronic power connection between a power source and a device, said connection clip further comprising:
a pair of complementary dimorphic elements, the first member of said pair being a linking element and the second member of said pair being a gripping element;
said linking element further comprising:
an insulating, shaped body comprising at least one central hole;
a set of electrically-conductive wires within said insulating, shaped body;
at least one set of electrically-conductive, spring-loaded, contact bumps that protrude through minimally and perpendicularly to the chief plane of the linking element's insulated outer shell, connecting to said electrically-conductive wiring; and,
a power cord comprising an insulating outer shell and internal electrically-conductive wiring, for connecting to the power source; and,
said gripping element further comprising:
an insulating outer shell;
a set of electrically-conductive wires within said insulating outer shell;
a first interior surface of said outer shell;
a spring hinge attached to and offset and near one end of said first interior surface of the outer shell;
a capping plate also attached to said spring hinge with a second interior surface having its axis and width parallel to and opposite said first interior surface;
at least one holding tooth, extruding from the second interior surface perpendicularly towards the first interior surface, said holding tooth's shape and form matching the central hole of the linking element; and,
at least one set of fixed, perpendicularly-protruding, and electrically-conductive contact points, connected to the set of electrically-conductive wires and protruding through the first interior face, said contact points in number and position, and thus a flow of electrical power, when the holding tooth is inserted through the central hole, between set of contact points and the set of contact bumps of the linking element;
so through power cord, electrically conductive interior wires, contact bumps, contact points, and electrically-conductive interior wires, an electrical connection is effected from the power source to the device.

2. A connection clip for electronic power connection as in claim 1, further comprising:
for the linking element, an orientation of the at least one set of electrically-conductive, spring-loaded, contact bumps locating them between the central hole and the power cord, such that their orientation is orthogonal to the orientation of the power cord which is in the chief plane of the body and extends directly away from it along a line drawn from the central hole through the middle of the set of contact bumps; and,
for the gripping element, an matching position and orientation of the contact points.

3. A connection clip for electronic power connection as in claim 1, wherein the gripping element further comprises for each contact point a water-resistant seal separating it from the insulating outer shell.

4. A connection clip for electronic power connection as in claim 1, wherein the gripping element further comprises for each contact point a water-proof seal separating it from the insulating outer shell.

5. A connection clip for electronic power connection as in claim 1, wherein the gripping element further comprises a releasable latch between its first and second interior faces.

6. A connection clip for electronic power connection as in claim 1, further comprising:
for the linking element's outer body, curved corners and edges; and,
for the gripping element's outer shell, curved corners and edges.

7. A connection clip for electronic power connection as in claim 1, wherein the gripping element further comprises an embedded light to signal that an electrical power connection is effected and power is flowing, which illuminates only when the gripping element and linking element are connected sufficiently to provide electrical power from the power source to the device.

8. A connection clip for electronic power connection as in claim 1, wherein the linking element and gripping element share respective lock-and-key designs and thus are complementarily matched in differing geometries, including higher-order topologies.

9. A connection clip for electronic power connection as in claim 1, wherein the linking element and gripping element respectively incorporate at least three contact points and contact bumps, connecting respectively to ‘ground’ ‘neutral, and ‘hot’ interior wires to enable a ‘3-prong’, grounded, connection.

10. A connection clip for electronic power connection as in claim 1, comprising:
a fitting within the central hole of the linking element further comprising a set of contact indents matching a known standard for data and/or power transmission through the power cord; and,
extruding from the first interior face of the gripping element a matching standard plug further comprising a complementary set of contact points;
such that by combining the two when the connecting plate is closed, the connection clip provides both data and power to, and taking data from, the instrumentation through the connection clip.

11. A connection clip for electronic power connection between a power source and a device, said connection clip further comprising:
at least one pair of complementary dimorphic elements, the first member of each said pair being a linking element and the second member of each said pair being a gripping element;
each said linking element further comprising:
an insulating, shaped body comprising at least one central hole;
a set of electrically-conductive wires within said insulating, shaped body;
at least one set of electrically-conductive, spring-loaded, contact bumps that protrude through minimally and perpendicularly to the chief plane of the linking element's insulated outer shell, connecting to said electrically-conductive wiring; and,
a power cord comprising an insulating outer shell and internal electrically-conductive wiring, for connecting to the power source; and,
each said gripping element further comprising:
an insulating outer shell;
a set of electrically-conductive wires within said insulating outer shell;
a first interior surface of said outer shell;
a spring hinge attached to and offset and near one end of said first interior surface of the outer shell;
a capping plate also attached to said spring hinge with a second interior surface having its axis and width parallel to and opposite said first interior surface;
at least one holding tooth, extruding from the second interior surface perpendicularly towards the first interior surface, said holding tooth's shape and form matching the central hole of the linking element; and,
at least one set of fixed, perpendicularly-protruding, and electrically-conductive contact points, connected to the set of electrically-conductive wires and protruding through the first interior face, said contact points in number and position, and thus a flow of electrical power, when the holding tooth is inserted through the central hole, between set of contact points and the set of contact bumps of the linking element;
so through the power cord, electrically conductive interior wires, contact bumps, contact points, and electrically-conductive interior wires of any one pair of gripping and linking elements an electrical connection is effected from the power source to the device.

12. A connection clip for electronic and data power connection between a power source and a device, said connection clip further comprising:
a pair of complementary dimorphic elements, the first member of said pair being a linking element and the second member of said pair being a gripping element;
said linking element further comprising:
an insulating, shaped body comprising at least one central hole;
a set of electrically-conductive wires within said insulating, shaped body wherein at least one electrically-conductive wire conducts data;
at least one set of electrically-conductive, spring-loaded, contact bumps that protrude through minimally and perpendicularly to the chief plane of the linking element's insulated outer shell, connecting to said electrically-conductive wiring; and,
a power cord comprising an insulating outer shell and internal electrically-conductive wiring, for connecting to the power source; and,
said gripping element further comprising:
an insulating outer shell;
a set of electrically-conductive wires within said insulating outer shell wherein at least one electrically-conductive wire conducts data;
a first interior surface of said outer shell;
a spring hinge attached to and offset and near one end of said first interior surface of the outer shell;
a capping plate also attached to said spring hinge with a second interior surface having its axis and width parallel to and opposite said first interior surface;
at least one holding tooth, extruding from the second interior surface perpendicularly towards the first interior surface, said holding tooth's shape and form matching the central hole of the linking element; and,
at least one set of fixed, perpendicularly-protruding, and electrically-conductive contact points, connected to the set of electrically-conductive wires and protruding through the first interior face, said contact points in number and position to effect a flow of electrical power and data, when the holding tooth is inserted through the central hole, between the set of contact points and the set of contact bumps of the linking element;
so through power cord, electrically conductive interior wires, contact bumps, contact points, and electrically-conductive interior wires of any of said set of pair, an electrical connection for power to and data from is effected between the device and an external source.
